(19) United States
(12) Patent Application Publication
(10) Pub. No.: US 2023/0120046 A1
(43) Pub. Date: Apr. 20, 2023

(54) MACHINING DIAGNOSIS DEVICE, LEARNING DEVICE, INFERENCE DEVICE, MACHINING DIAGNOSIS METHOD AND RECORDING MEDIUM

(71) Applicant: Mitsubishi Electric Corporation, Tokyo (JP)

(72) Inventors: Tetsushi ISHIDA, Tokyo (JP); Kenichi HORI, Tokyo (JP)

(73) Assignee: Mitsubishi Electric Corporation, Tokyo (JP)

(21) Appl. No.: 17/915,545

(22) PCT Filed: Nov. 12, 2020
(86) PCT No.: PCT/JP2020/042185

§ 371 Date: Sep. 29, 2022

(51) Int. Cl. G05B 23/02; B23Q 17/09

(52) U.S. Cl. CPC G05B 23/0245; B23Q 17/0952; G05B 23/0278; G05B 23/0221

(57) ABSTRACT

A machining diagnosis device (100) includes a machining data acquirer (3) to acquire, from a machining tool (1), machining data including a result of machining performed based on a machining condition, a cutting section extractor (4) to extract, from the acquired machining data, a cutting section corresponding to a stable machining period and machining data for the cutting section, a cleansing unit (8) to acquire the machining condition for cutting and perform, in accordance with the acquired machining condition, cleansing of the machining data extracted by the cutting section extractor (4), a feature calculator (9) to calculate a feature based on the cleansed machining data, and a machining diagnoser (11) to diagnose machining based on the calculated feature.

### TECHNICAL FIELD

The present disclosure relates to a machining diagnosis device, a learning device, an inference device, a machining diagnosis method, and a program.

### BACKGROUND ART

Machining tools have components to be replaced before any defective product is produced to reduce defective products due to worn or broken components. However, such replacement is performed based not on the actual wear states of the components but on, for example, the number of times work is performed on workpieces, causing still usable components to be discarded or excess replacement work to be performed. Thus, machining data acquired from a machining tool is used to diagnose the wear state of a component, predicting the service life of the component and optimizing the replacement time of the component.

Patent Literature 1 describes a numerical control device that determines occurrence of any component abnormality based on a current flowing through a motor that drives the component. The numerical control device performs determination on occurrence of a component abnormality when determining that the motor is in a constant speed, and does not perform the determination when determining that the motor is accelerating or decelerating to increase the accuracy of occurrence of a component abnormality.

### CITATION LIST

### Patent Literature

Patent Literature 1: Unexamined Japanese Patent Application Publication No. 2020-13433

### SUMMARY OF INVENTION

### Technical Problem

The above technique uses machining data throughout the machining period to determine occurrence of an abnormality. To determine an abnormality by acquiring machining data and analyzing the machining data afterwards, data unusable for abnormality determination is to be processed, thus causing inefficient data processing.

In response to the above issue, an objective of the present disclosure is to eliminate data processing of machining data unusable for abnormality determination and allow more accurate machining diagnosis based on highly accurate data.

### Solution to Problem

To achieve the above objective, a machining diagnosis device according to an aspect of the present disclosure includes a machining data acquirer to acquire, from a machining tool, machining data including a result of machining performed based on a machining condition, a cutting section extractor to extract, from the acquired machining data, a cutting section corresponding to a stable machining period and machining data for the cutting section, a cleansing unit to acquire the machining condition and perform, in accordance with the acquired machining condition, cleansing of the machining data extracted by the cutting section extractor, a feature calculator to calculate a feature based on the cleansed machining data, and a machining diagnoser to diagnose machining based on the calculated feature.

### Advantageous Effects of Invention

The above aspect of the present disclosure allows efficient and accurate machining diagnosis based on highly accurate data.

### BRIEF DESCRIPTION OF DRAWINGS

FIG. 1 is a block diagram of a machining diagnosis device according to Embodiment 1 of the present disclosure;

FIG. 2 is a diagram of the machining diagnosis device according to Embodiment 1 of the present disclosure, illustrating an example hardware configuration;

FIG. 3 is a waveform diagram of a cutting section in machining data in Embodiment 1 of the present disclosure;

FIG. 4 is a flowchart of operations for a feature calculation process in Embodiment 1 of the present disclosure;

FIG. 5 is a flowchart of operations for a prediction model generation process in Embodiment 1 of the present disclosure;

FIG. 6 is a flowchart of a calculation process of a machining quality prediction model in Embodiment 1 of the present disclosure;

FIG. 7 is a block diagram of a learning device according to Embodiment 2 of the present disclosure;

FIG. 8 is a flowchart of operations for a learning process in Embodiment 2 of the present disclosure;

FIG. 9 is a block diagram of an inference device according to Embodiment 2 of the present disclosure; and

FIG. 10 is a flowchart of operations for a process for acquiring an output in Embodiment 2 of the present disclosure.

### DESCRIPTION OF EMBODIMENTS

A machining diagnosis device 100 according to one or more embodiments of the present disclosure is now described with reference to the drawings. In the drawings, the same reference signs denote the same or equivalent components.

### Embodiment 1

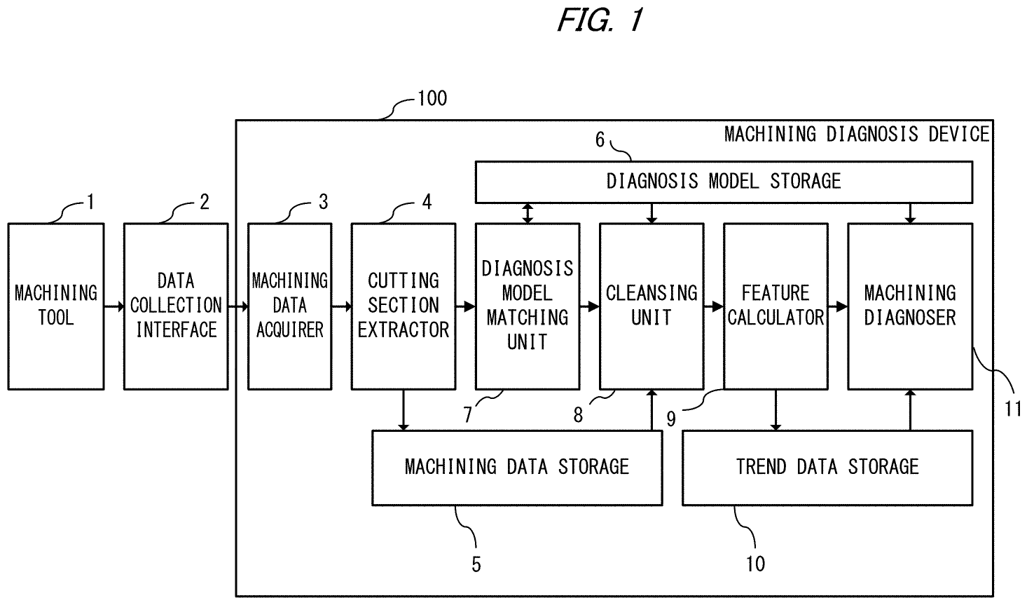

The machining diagnosis device 100 according to Embodiment 1 is described with reference to FIG. 1. The machining diagnosis device 100 includes a machining data acquirer 3 that acquires machining data from a machining tool 1 through a data collection interface 2, a cutting section extractor 4 that extracts a cutting section and machining data for the cutting section from the acquired machining data, a machining data storage 5 that stores the extracted machining data, a diagnosis model storage 6 that stores multiple diagnosis models, a diagnosis model matching unit 7 that extracts a diagnosis model corresponding to a machining condition from the diagnosis model storage 6, a cleansing unit 8 that cleanses the machining data based on the extracted diagnosis model, a feature calculator 9 that extracts features from the cleansed machining data, a trend data storage 10 that stores the calculated features, and a machining diagnoser 11 that diagnoses any machining abnormality based on the calculated features and statistic quantities using the features stored in the trend data storage 10 as a population.

The machining data acquirer 3 acquires machining data through the data collection interface 2 attached to the machining tool 1, stores the machining data temporarily, and provides a set of a certain amount of machining data to the cutting section extractor 4. The machining tool 1 is a machine for scraping, cutting, grinding, or performing another machining operation on a workpiece, and is, for example, a milling machine, a lathe, or a drilling machine.

The machining data acquired by the machining data acquirer 3 includes machining information (manufacturing information such as the number of a machining program, the number of a subprogram, the number of a component, a main spindle rotational speed command, manufacturing serial information, and machining dimension inspection results), motor specifications data during machining (e.g., motor speed and motor torque), and machining-related information (e.g., cutting oil ejection pressure and cutting oil temperature).

The cutting section extractor 4 extracts a cutting section corresponding to a stable machining period from the machining data acquired by the machining data acquirer 3 and extracts machining data for the extracted cutting section. The extracted machining data is stored into the machining data storage 5. The stable machining period is a period during which a main spindle motor is in a constant speed and can perform machining stably. The cutting section corresponding to the stable machining period is a section of a cutting area that corresponds to the stable machining period during which the main spindle motor rotates stably without accelerating or decelerating. Machining abnormality determination is performed by extracting the cutting section corresponding to the stable machining period and collecting data for the section to reduce errors in determining machining abnormality.

To extract a cutting section from data sampled from the main spindle motor, the timing to start or end collecting stable-state data is defined in accordance with combination conditions of an achievement degree to a target value of a main spindle rotational speed command (motor speed command) for the machining tool 1 and a threshold for motor torque (acceleration torque Ta and deceleration torque Td).

When the signal for starting or ending cutting is acquirable directly from the machining tool 1, the signal directly acquired from the machining tool 1 is defined as the timing to start or end the collection.

The diagnosis model storage 6 stores machining patterns formed in accordance with machining conditions, such as the number of a subprogram, the number of a component, a main spindle rotational speed command, as diagnosis models each for a different machining condition. The diagnosis model is determined uniquely for each of a machine, a subprogram, and a component. Machining patterns include different machining points, sizes, and ranges depending on the work performed based on a program. Actual machining is performed at machining points in one machining section, and no actual machining is performed during the transition to a subsequent machining point. Data acquired for the sections in which no actual machining is performed is unusable for machining diagnosis. The diagnosis model storage 6 uses sections in the cutting section in which actual machining is performed as subsections and defines conditions for the subsections from which features for a diagnosis target population are extracted. The conditions for the beginning and the end of the subsection are defined with a threshold level for torque fluctuations of a motor shaft for cutting and the number of times the maximum threshold or the minimum threshold is exceeded at a time after a specific period from when machining and collection is triggered.

The diagnosis model matching unit 7 extracts a diagnosis model that corresponds to a machining condition from the diagnosis model storage 6. The machining condition acquired from the machining data acquirer 3 is compared with machining conditions of the diagnosis models preregistered in the diagnosis model storage 6. After the comparison, the machining pattern of a diagnosis model matching the machining condition is extracted. When the machining data acquirer 3 cannot collect machining conditions, such as the number of a machine, the number of a subprogram, or the number of a component, through the collection interface, a diagnosis model may be identified by measuring time from the start to the end of data collection for the cutting section extracted from the cutting section extractor 4 and comparing the measured time with machining times preregistered in the diagnosis model storage 6.

The cleansing unit 8 performs a cleansing process to exclude machining data unusable for machining diagnosis based on the extracted diagnosis model and leave usable machining data. The cleansing process is performed to exclude data for the sections in which no actual machining is performed in the machining pattern and leave data for the subsections in which actual machining is performed. The method for leaving data for the subsections may be selected between re-leaving the subsections by setting a start time and an end time for the cutting section and specifying the subsections by acquiring actual cutting signals directly from the machining tool 1.

The feature calculator 9 calculates features based on the machining data for the subsections resulting from the cleansing. Features include, for example, the same type of machining data collected in one machining section, such as a maximum, a minimum, a mean, a standard deviation, a numerical range, a machining duration, and an integrated value of a current.

The trend data storage 10 stores the features calculated by the feature calculator 9. The calculated features are stored as trend data for each model to be a statistical population (learning target) for diagnosis.

The machining diagnoser 11 diagnoses wear of a component based on the calculated features and statistic quantities using the features stored as trend data as a population. After completion of each machining operation, the machining diagnoser 11 extracts trend data for analysis to be a diagnosis target from the features stored in the trend data storage 10, and performs diagnosis using the target diagnosis model. The machining diagnosis is not limited to diagnosing wear, and may include detecting a machining abnormality and diagnosing any sign on a machine.

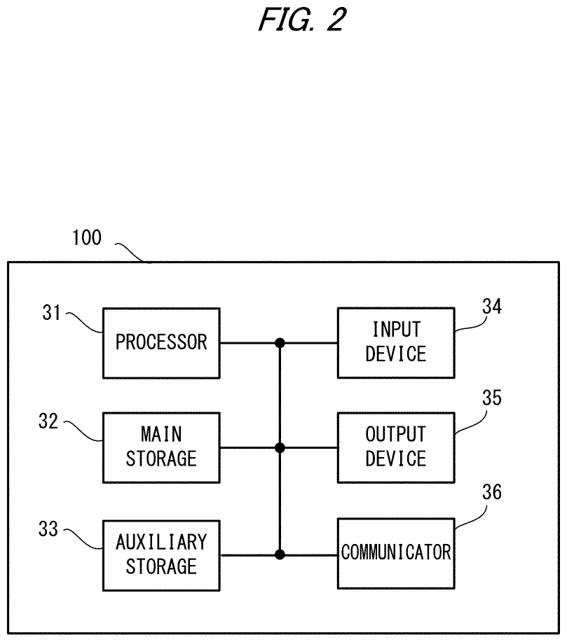

As illustrated in FIG. 2, the machining diagnosis device 100 includes, as hardware components, a processor 31 that processes data in accordance with a control program, a main storage 32 that serves as a work area for the processor, an auxiliary storage 33 that stores data over a long period, an input device 34 that receives input of data, an output device 35 that outputs data, a communicator 36 that communicates with other devices, and a bus that connects these elements to one another. The auxiliary storage 33 stores a control program for a data collection process to be executed by the processor. The details of the control program are described later. The input device 34 receives machining data transmitted from the machining tool 1 and provides the data to the processor 31. The processor 31 reads a program stored in the auxiliary storage 33 onto the main storage 32 and executes the program, thus serving as the machining data acquirer 3, the cutting section extractor 4, the diagnosis model matching unit 7, the cleansing unit 8, the feature calculator 9, and the machining diagnoser 11 illustrated in FIG. 1. The auxiliary storage 33 serves as the machining data storage 5, the diagnosis model storage 6, and the trend data storage 10.

Operations performed by the machining diagnosis device 100 with the above structure are now described.

Operations of the machining diagnosis device 100 include a learning process to learn the relationship between the features calculated by the feature calculator 9 and machining quality to generate a machining quality prediction model and a machining process to predict machining quality in actual machining of a workpiece.

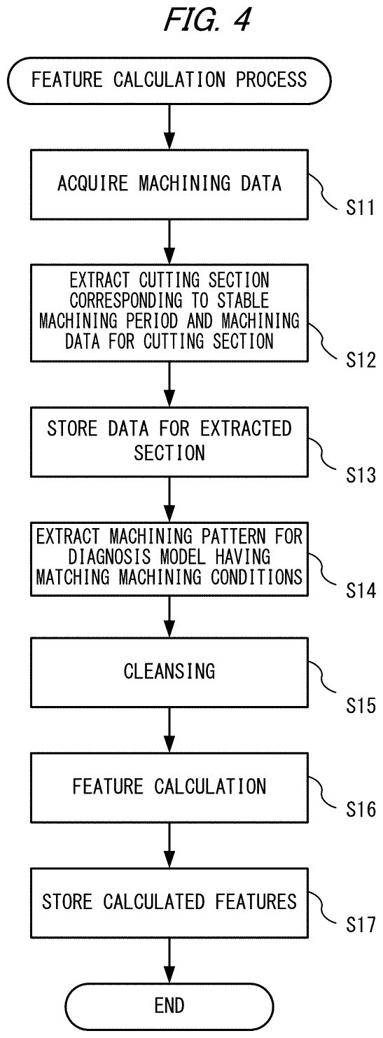

The learning process is described first. In FIG. 4, at the start of machining on a workpiece, the machining data acquirer 3 acquires machining data including machining information (manufacturing information such as the number of a machining program, the number of a subprogram, the number of a component, a main spindle rotational speed command, manufacturing serial information, and machining dimension inspection results), motor specifications data during machining (e.g., motor speed and motor torque), and machining-related information (e.g., cutting oil ejection pressure and cutting oil temperature) (step S11).

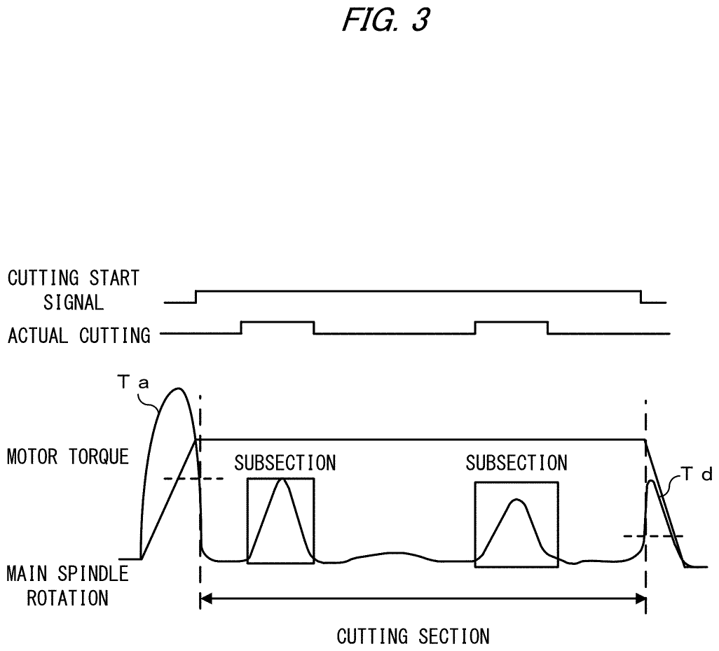

After the machining data is acquired, the cutting section extractor 4 extracts, from the machining data, a cutting section corresponding to a stable machining period and machining data for the cutting section (step S12). Extraction of the cutting section corresponding to the stable machining period is described with reference to FIG. 3.

FIG. 3 illustrates the motor torque of the main spindle motor in the machining tool 1, a main spindle motor rotational speed command, a cutting start signal, and an actual cutting signal in one cutting section. When cutting is started, the main spindle motor is rotated until the rotational speed increases to the speed corresponding to the main spindle motor rotational speed command. In this state, the main spindle motor accelerates and thus produces acceleration torque Ta as motor torque. In FIG. 3, the first wave crest for the motor torque indicates the acceleration torque Ta. The acceleration torque Ta may cause an error when used as data for machining diagnosis, and the section with the acceleration torque Ta is to be excluded from the cutting section for extraction. Thus, the time point after the rotational speed of the main spindle motor achieving, for example, 80% of the target rotational speed and the acceleration torque Ta decreasing from a peak to a threshold is defined as the timing to start stable-state data collection for extracting the cutting section. When machining is complete and the rotational speed of the main spindle motor decreases, the decelerating main spindle motor produces deceleration torque Td as motor torque. In FIG. 3, the rightmost wave crest of the motor torque indicates the deceleration torque Td. Similarly to the acceleration torque Ta, the deceleration torque Td may cause an error when used as data for machining diagnosis, and the section with the deceleration torque Td is to be excluded from the cutting section for extraction. Thus, the time point at which the rotational speed of the motor decreases and the deceleration torque Td that has started increasing exceeds a threshold is defined as the timing to end stable-state data collection at which extraction of the cutting section is ended.

Referring back to FIG. 4, the cutting section extractor 4 stores machining data pieces for the section extracted by the cutting section extractor 4 sequentially into the machining data storage 5 (step S13).

Subsequently, the diagnosis model matching unit 7 compares the machining conditions acquired from the machining data acquirer 3 with the machining conditions preregistered in the diagnosis model storage 6, and extracts a machining pattern for the diagnosis model having machining conditions matching the acquired machining conditions (step S14).

The cleansing unit 8 performs the cleansing process to exclude machining data unusable for machining diagnosis based on the extracted machining pattern of the diagnosis model and leave useful data (step S15).

The feature calculator 9 calculates features based on the machining data for the subsections resulting from the cleansing (step S16).

The features calculated by the feature calculator 9 is then stored into the trend data storage 10 (step S17).

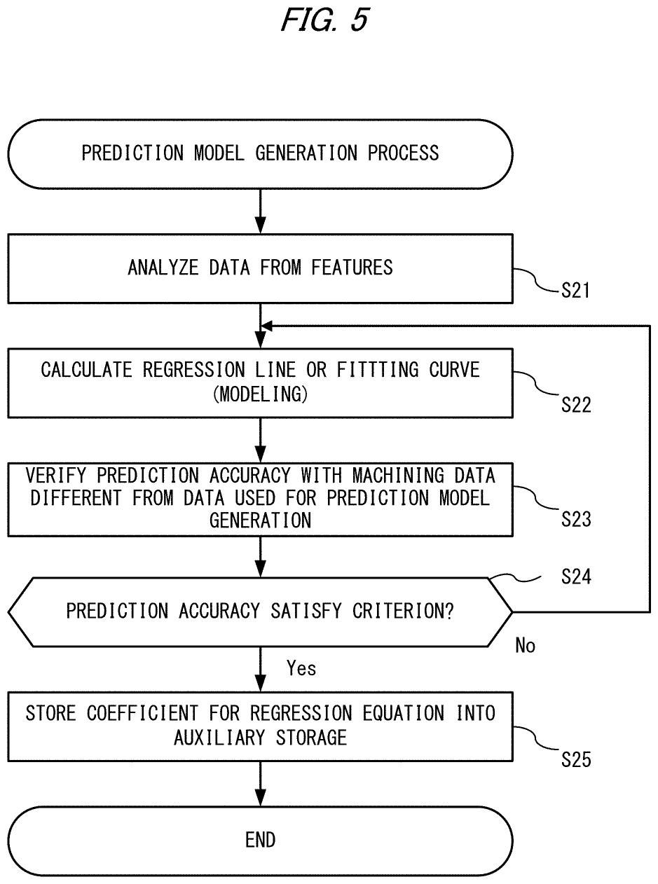

After the feature calculation process, the machining diagnoser 11 diagnoses wear of a component based on the calculated features and statistic quantities using the features stored as trend data as a population. The machining diagnoser 11 reads the feature data and the machining data and starts a prediction model generation process illustrated in FIG. 5. The machining diagnoser 11 first excludes abnormal values from the features representing machining features, and performs an analysis process to calculate data such as a contribution ratio, a correlation efficient, and multicollinearity (step S21).

The machining diagnoser 11 then calculates a regression line or a fitting curve to generate a prediction model (step S22). In the present embodiment, the prediction model is a regression equation determined by the least squares method. In approximating a set of values acquired from measurement with a function, the least squares method is used to determine a coefficient that minimizes the sum of the squares of residuals, thus allowing a closer approximation between the estimated function and the measured values.

A specific regression equation to be determined is described below.

y=Ax1+Bx2+Cx3++N×n (1)

In the equation, y is a response variable, each xk (k=1, 2, . . . , n) is an explanatory variable, and A, B, C, . . . , N are coefficients for the respective explanatory variables.

In the present embodiment, the explanatory variable x1 is a feature of the motor torque in the subsections. The response variable y is a difference between a design value of machining dimensions for a workpiece and a measured value. Regression analysis is used to calculate a coefficient A for a regression equation, y=Ax1, that most fits the feature (x1) extracted from multiple pieces of machining data. The regression equation is determined for each cutting section in the machining process. In the present embodiment, modeling is performed based on the features collected in real time. In some embodiments, modeling may be performed based on features collected in the past and stored in the main storage 32 or the auxiliary storage 33.

The machining diagnoser 11 uses machining data different from the machining data used for generating the prediction model in step S22 to calculate the accuracy of the generated prediction model, or more specifically, the accuracy of prediction when the machining data is input into the regression equation, to verify accuracy (step S23).

The machining diagnoser 11 determines whether the prediction accuracy calculated in step S23 satisfies a criterion (step S24).

When the machining diagnoser 11 determines that the prediction accuracy does not satisfy the criterion (No in step S24), the process return to step S22. When the machining diagnoser 11 determines that the prediction accuracy satisfies the criterion (Yes in step S24), the generated model, or more specifically, the coefficient A for the regression equation in this example, is stored into the auxiliary storage 33 in a manner associated with the machining process and the machining section (step S25).

In this manner, the prediction model is generated to predict machining dimensions or machining quality in an actual machining process. The learning process is performed at any frequency in each machining process.

The machining diagnoser 11 calculates the contribution ratio for correlation for each regression equation determined in step S22, or more specifically, the degree of contribution of each explanatory variable xk to a response variable y, and determines the accuracy of the contribution ratio using a multiple correlation coefficient R.

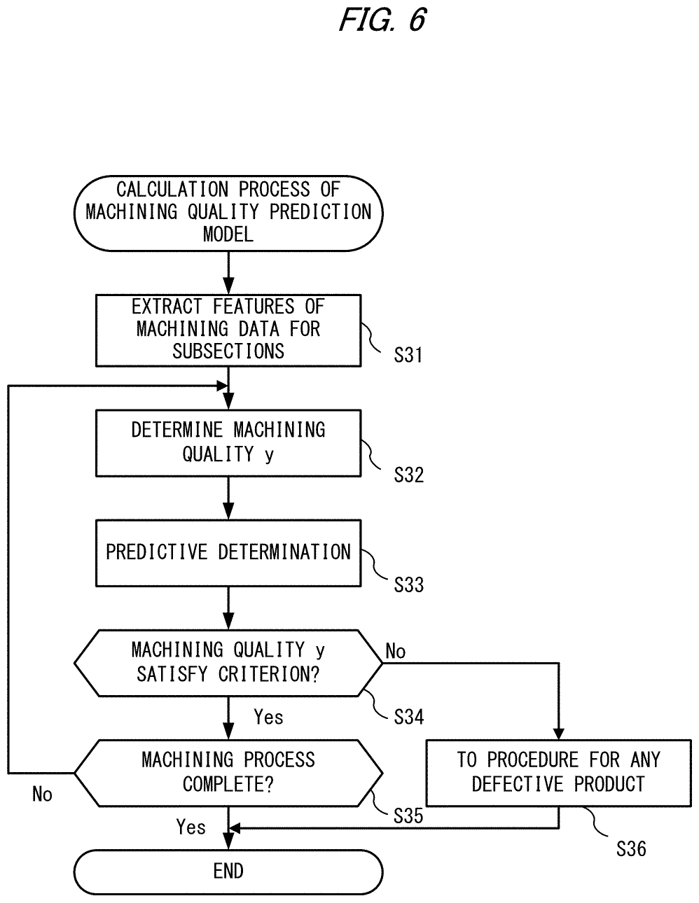

A process for predicting machining dimensions or machining quality using a prediction model in an actual machining process is now described with reference to FIG. 6.

For machining a workpiece using the machining tool 1, the machining data acquirer 3 acquires machining data from the machining tool 1 through the data collection interface 2 and extracts features of machining data for subsections in a cutting section (step S31).

Subsequently to the feature extraction, machining quality at the time point is predicted by inputting newly acquired machining data into the regression equation serving as a prediction model to determine a machining quality y predicted at the time point (step S32). More specifically, the regression equation, y=Ax1, is substituted with x1=motor torque extracted from the machining data to predict the machining quality y that is an absolute value of the difference between a design value and a predicted dimension.

Predictive determination is performed by fitting the machining quality y to previous machining predictive values using a fitting curve until the workpiece is out of the dimensional tolerances (step S33).

The machining diagnoser 11 refers to reference machining dimension quality predetermined for each machining process and determines whether the predicted machining quality y satisfies the corresponding criterion (step S34). When determining that the predicted machining quality y satisfies the criterion (Yes in step S34), the machining diagnoser 11 determines whether the machining process is complete (step S35). When the machining process is not complete (No in S35), the process returns to step S32 for the processing in the next section. When the machining process is complete (Yes in step S35), the process ends.

When the machining diagnoser 11 determines that the predicted machining quality y does not satisfy the criterion (No in step S34), the process advances to a procedure for any defective product (step S36).

The steps described above are performed to predict the quality of the final machining dimension while the workpiece is being machined.

As described above, analysis is performed with the established multiple regression analysis, and prediction is performed with a method involving less calculation, or more specifically, substitution into regression equations. This allows faster and more stable analysis and prediction than using a complicated method such as a neural network, fuzzy theory, or deep learning.

A component replacement time is determined based on the determined machining quality. The machining diagnosis device 100 determines a straight line representing the relationship between a series of predicted machining qualities and elapsed time by, for example, the least squares method. The machining diagnosis device 100 identifies the time at which the fitting curve including the determined straight line intersects with the dimensional tolerance and indicates the time as the component replacement time. More specifically, for a linear fitting curve, machining quality decreases proportional to elapsed time and thus reaches below a criterion at the time the fitting curve intersects with the dimensional tolerance. The fitting curve may represent machining quality changing gently or steeply as time elapses. The fitting curve may be expressed with a more complex function, and may be any function other than the above example that can reproduce the machining data more accurately. Thus, the operator can determine the time for replacing components in advance.

### Embodiment 2

In the present disclosure, data during air-cutting performed before actual production is started and during test machining is collected to perform learning about the characteristics of a torque waveform or a motor speed in acceleration and deceleration. This allows automatic determination of the timing to start or end stable-state data collection that defines a cutting section. Learning is performed by machine learning or reinforcement learning (Q-learning).

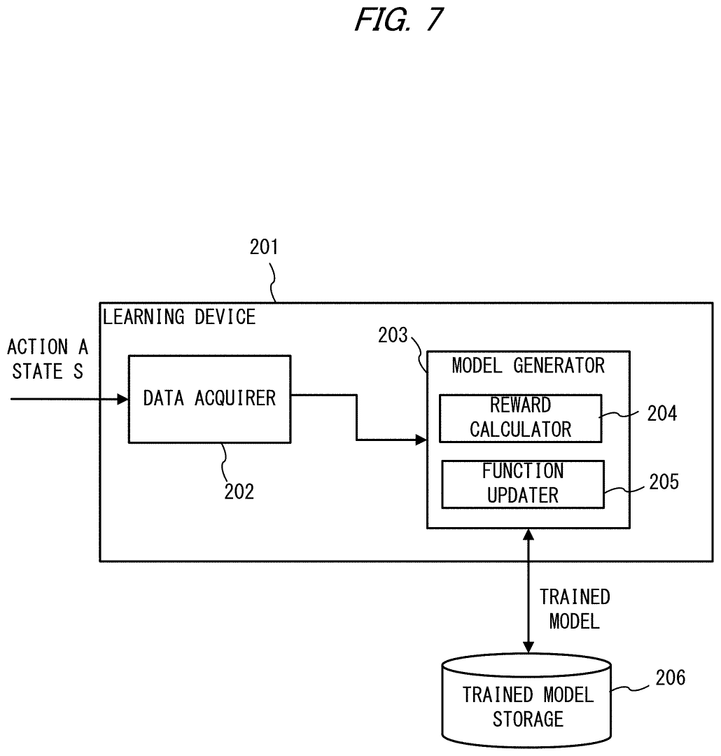

FIG. 7 is a block diagram of a machine learning device for the machining diagnosis device 100. A learning device 201 includes a data acquirer 202 and a model generator 203.

The data acquirer 202 acquires, as training data, an action A including the timing to start or end collection of data for a stable state in which rotation of the motor is stable and a state S including the torque waveform, a motor speed waveform, an acceleration waveform, a current waveform, and a voltage waveform during each of air-cutting and test machining.

The model generator 203 learns, based on the training data including the action A including the timing to start or end stable-state data collection and the state S including at least one of the torque waveform, the motor speed waveform, the acceleration waveform, the current waveform, or the voltage waveform during each of air-cutting and test machining, the timing to start or end stable-state data collection for calculating features that allow acquisition of the most accurate wear diagnosis result as an optimal action A. In other words, the model generator 203 generates a trained model that infers the optimal action A based on the state S in the machining diagnosis device 100. The waveforms of the action A include slopes of the waveforms, slopes of biases for the waveforms, and the amount of change in the slopes of the waveforms.

The model generator 203 may use a known learning algorithm such as supervised learning, unsupervised learning, or reinforcement learning. In the example described below, reinforcement learning is used. In reinforcement learning, an agent (action performer) in an environment observes a current state (parameters in the environment) and determines an action to perform. The action of the agent dynamically changes the environment, and the agent receives a reward in accordance with the changes in the environment. The agent repeats the process and learns an action policy that maximizes rewards to be acquired over the series of actions. Q-learning and temporal difference (TD) learning are known as typical reinforcement learning methods. In Q-learning, for example, a general update expression for action value function Q(s, a) is indicated with expression 2.

Q(sₜ, aₜ)←Q(sₜ, aₜ)+α(rₜ₊₁+γmaxₐQ(sₜ₊₁, aₜ₊₁)−Q(sₜ, aₜ)) (2)

In expression 2, sₜ is the state of environment at time t, and aₜ is the action at time t. The action aₜ changes the state to sₜ₊₁. A reward acquired from any change of the state is rₜ₊₁, γ is a discount factor with a range of 0<γ≤1, and α is a learning coefficient with a range of 0<α≤1. The action A is the action aₜ and the state S is the state sₜ. The agent learns an optimal action aₜ in the state sₜ at time t.

The update expression indicated with expression 2 yields a greater action value Q when an action value Q of an action a having the greatest Q-value at time t+1 is greater than an action value Q of the action a performed at time t and yields a less action value Q when the action value Q at time t+1 is less than the action value Q performed at time t. In other words, the action value function Q(s, a) is updated to approximate the action value Q of the action a at time t to the optimal action value at time t+1. Thus, an optimal action value in an environment affects an action value in an earlier stage of the environment in a sequential manner.

For the trained model generated by reinforcement learning as described above, the model generator 203 includes a reward calculator 204 and a function updater 205.

The reward calculator 204 calculates a reward based on the action A and the state S. The reward calculator 204 calculates a reward r using a reward criterion that is an error range of the wear diagnosis result based on features from an actual wear diagnosis result. When the timing to start or end stable-state data collection is not acquired accurately, more unstable-state data is acquired and does not allow correct selection of features. This can lower the accuracy of wear diagnosis results based on features. Thus, the reward criterion is whether a wear diagnosis result is in a criterial error range. For a reward-increasing criterion, or more specifically, for the wear diagnosis result based on features being within the criterial error range, the reward r is increased (e.g., a reward of 1 is provided). For a reward-decreasing criterion, or more specifically, for the wear diagnosis result based on features deviating from the criterial error range, the reward r is decreased (e.g., a reward of −1 is provided).

The function updater 205 updates, in accordance with the reward calculated by the reward calculator 204, a function for determining an optimal action A and outputs the function to a trained model storage 206. In Q-learning, for example, the action value function Q(sₜ, aₜ) indicated with expression 2 is used as the function for calculating the optimal action A.

The learning process as described above is performed repeatedly. The trained model storage 206 stores the action value function Q(sₜ, aₜ) updated by the function updater 205, or more specifically, stores a trained model.

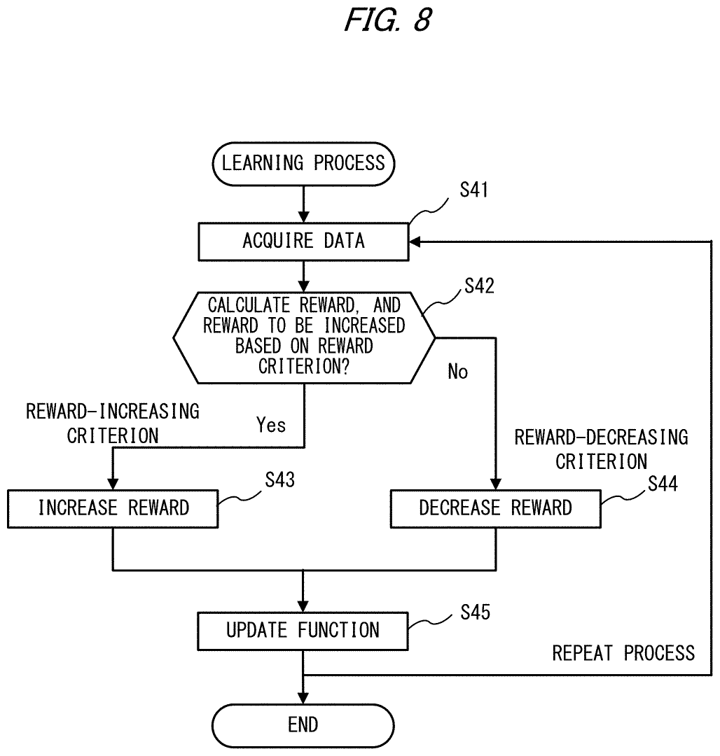

A learning process performed by the learning device 201 is now described with reference to FIG. 8. FIG. 8 is a flowchart of the learning process performed by the learning device 201.

In step S41, the data acquirer 202 acquires an action A and a state S as training data.

In step S42, the model generator 203 calculates a reward based on the action A and the state S. More specifically, the reward calculator 204 acquires the action A and the state S and determines whether to increase or decrease the reward based on a predetermined reward criterion.

When determining to increase the reward (Yes in step S42), the reward calculator 204 increases the reward in step S43. When determining to decrease the reward (No in step S42), the reward calculator 204 decreases the reward in step S44.

In step S45, the function updater 205 updates, based on the reward calculated by the reward calculator 204, the action value function Q(sₜ, aₜ) indicated with expression 2 stored in the trained model storage 206.

The learning device 201 repeats the process in the above steps S41 through S45 and stores the generated action value function Q(sₜ, aₜ) as a trained model.

The learning device 201 according to the present embodiment stores the trained model into the trained model storage 206 external to the learning device 201. In some embodiments, the trained model storage 206 may be incorporated in the learning device 201.

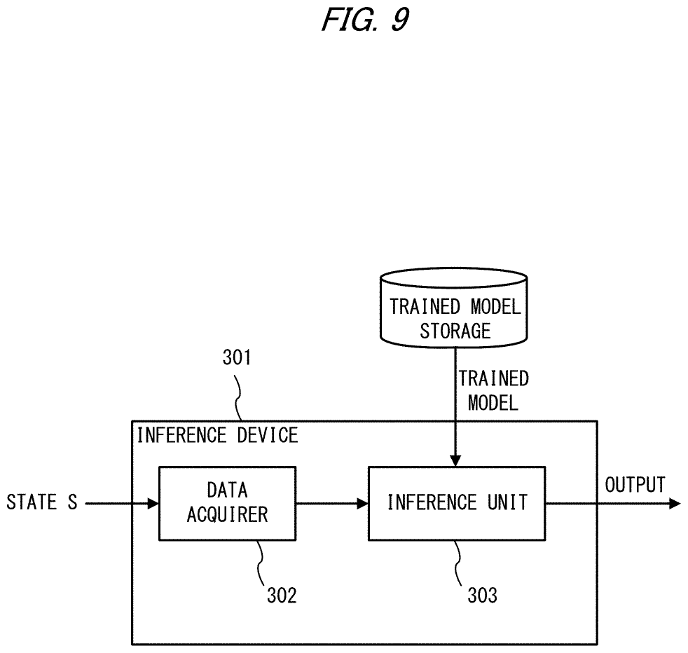

FIG. 9 is a block diagram of an inference device 301 for the machining diagnosis device 100. The inference device 301 includes a data acquirer 302 and an inference unit 303.

The data acquirer 302 acquires a state S.

The inference unit 303 uses a trained model to infer an optimal action A. In other words, the state S acquired by the data acquirer 302 is input into the trained model to allow inference of the optimal action A for the state S. The state S to be input is data including at least one of the torque waveform, a motor speed waveform, an acceleration waveform, a current waveform, or a voltage waveform in actual machining.

In the present embodiment described above, the optimal action A is output using the trained model learned by the model generator 203 in the learning device 201 for the machining diagnosis device 100. In some embodiments, the optimal action A may be output based on the trained model acquired from another machining diagnosis device 100.

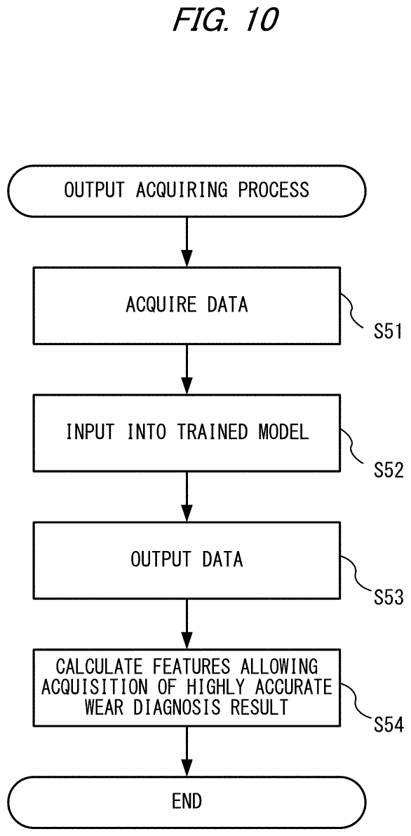

A process for acquiring an optimal action A using the learning device 201 is now described with reference to FIG. 10.

In step S51, the data acquirer 302 acquires a state S.

In step S52, the inference unit 303 inputs the state S into the trained model stored in the trained model storage 206 and acquires an optimal action A (step S53).

The inference unit 303 outputs the acquired optimal action A to the machining diagnosis device 100.

In step S54, the machining diagnosis device 100 uses the output optimal action A to calculate features that allow acquisition of a highly accurate wear diagnosis result.

In the present embodiment described above, the learning algorithm used by the inference unit 303 is reinforcement learning. In some embodiments, the inference unit 303 may use other algorithms. Learning algorithms other than reinforcement learning may include supervised learning, unsupervised learning, or semi-supervised learning.

The model generator 203 may use deep learning for learning extraction of features as a learning algorithm or may perform machine learning in accordance with other known methods such as a neural network, genetic programming, functional logic programming, or a support-vector machine.

The learning device 201 and the inference device 301 may be connected to the machining diagnosis device 100 through, for example, a network and may be separate from the machining diagnosis device 100. The learning device 201 and the inference device 301 may be incorporated in the machining diagnosis device 100. The learning device 201 and the inference device 301 may be located on a cloud server.

The model generator 203 may learn an optimal action A using training data acquired from multiple machining diagnosis devices 100. The model generator 203 may acquire training data from multiple machining diagnosis devices 100 used in the same area, or may use training data collected from multiple machining diagnosis devices 100 operating independently of one another in different areas to learn an optimal action A. A machining diagnosis device 100 to collect training data may be added or removed during the process. A learning device 201 that has learned an optimal action A for one machining diagnosis device 100 may be used for another machining diagnosis device 100, and may relearn and update the optimal action A for the other machining diagnosis device 100.

### Embodiment 3

For maintenance of machines, machining data before and after maintenance may be learned to reduce effect of mechanical loss changes on machining data (motor torque) and correct diagnostic thresholds for determining an abnormality in different diagnosis capabilities. When a motor is replaced in machine maintenance, replacing, for example, a bearing to a new bearing reduces the load from bearing rotation. Thus, motor torque for the same machining operation is less after the maintenance than before the maintenance. Such decrease in motor torque is corrected to reduce effect of replacing the motor. Learning is performed by machine learning or reinforcement learning (Q-learning).

The block diagram of the machine learning device for the machining diagnosis device 100 is the same as in FIG. 7 and is not illustrated.

The data acquirer 202 acquires, as training data, an action A including diagnostic conditions, such as diagnostic parameters and manners of using data (the used part of the data after the maintenance and the manner in which the data is processed) and a state S including machining data after the maintenance, such as a torque waveform and a main spindle speed waveform.

The model generator 203 learns, based on the training data including the action A including diagnostic conditions, such as diagnostic parameters and the manner of using data (the used part of the data after the maintenance and the manner in which the data is processed) and the state S including the machining data after the maintenance, such as a torque waveform and a main spindle speed waveform, an appropriate diagnostic threshold correction value for each piece of data after the maintenance as an optimal action A. In other words, the model generator 203 generates a trained model for inferring the optimal action A based on the state S acquired from the machining diagnosis device 100.

The reward calculator 204 calculates a reward based on the action A and the state S. The reward calculator 204 calculates a reward r based on a reward criterion as to whether a difference between a theoretical diagnostic value and a diagnostic value calculated based on data after maintenance is in a criterial error range. For example, for a reward-increasing criterion, or more specifically, for the difference being within the criterial error range, the reward r is increased (e.g., a reward of 1 is provided). For a reward-decreasing criteria, or more specifically, for the difference deviating from the criterial error range, the reward r is decreased (e.g., a reward of −1 is provided).

The function updater 205 updates, in accordance with the reward calculated by the reward calculator 204, a function for determining an optimal action A and outputs the function to the trained model storage 206. In Q-learning, for example, the action value function Q(sₜ, aₜ) indicated with equation 1 is used as a function to calculate an optimal action A.

The learning process as described above is performed repeatedly. The trained model storage 206 stores the action value function Q(sₜ, aₜ) updated by the function updater 205, or more specifically, stores a trained model.

The learning process performed by the learning device 201 is the same as in FIG. 8 and is not illustrated. The block diagram of the inference device 301 for the machining diagnosis device 100 is also the same as in FIG. 9 and is not illustrated.

In the present embodiment described above, the learning algorithm used by the inference unit 303 is reinforcement learning. In some embodiments, the inference unit 303 may use other algorithms. Learning algorithms other than reinforcement learning may include supervised learning, unsupervised learning, or semi-supervised learning.

The model generator 203 may use deep learning for learning extraction of features as a learning algorithm or may perform machine learning in accordance with other known methods such as a neural network, genetic programming, functional logic programming, or a support-vector machine.

The learning device 201 and the inference device 301 may be connected to the machining diagnosis device 100 through, for example, a network and may be separate from the machining diagnosis device 100. The learning device 201 and the inference device 301 may be incorporated in the machining diagnosis device 100. The learning device 201 and the inference device 301 may be located on a cloud server.

The model generator 203 may learn an optimal action A using training data acquired from multiple machining diagnosis devices 100. The model generator 203 may acquire training data from multiple machining diagnosis devices 100 used in the same area, or may use training data collected from multiple machining diagnosis devices 100 operating independently of one another in different areas to learn an optimal action A. A machining diagnosis device 100 to collect training data may be added or removed during the process. A learning device 201 that has learned an optimal action A for one machining diagnosis device 100 may be used for another machining diagnosis device 100, and may relearn and update the optimal action A for the other machining diagnosis device 100.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is widely applicable to a machining diagnosis device 100.

### REFERENCE SIGNS LIST

1 Machining tool
2 Data collection interface
3 Machining data acquirer
4 Cutting section extractor
5 Machining data storage
6 Diagnosis model storage
7 Diagnosis model matching unit
8 Cleansing unit
9 Feature calculator
10 Trend data storage
11 Machining diagnoser
31 Processor
32 Main storage
33 Auxiliary storage
34 Input device
35 Output device
36 Communicator
100 Machining diagnosis device
201 Learning device
202, 302 Data acquirer
203 Model generator
204 Reward calculator
205 Function updater
206 Trained model storage
301 Inference device
303 Inference unit

1. A machining diagnosis device, comprising:
processing circuitry
to acquire, from a machining tool, machining data including a result of machining performed based on a machining condition,
to extract, from the acquired machining data, a cutting section corresponding to a stable machining period and machining data for the cutting section,
to acquire the machining condition and perform, in accordance with the acquired machining condition, cleansing of the extracted machining data,
to calculate a feature based on the cleansed machining data, and
to diagnose machining based on the calculated feature.

2. The machining diagnosis device according to claim 1, further comprising:
a storage device to store a machining pattern formed in accordance with the machining condition as a diagnosis model for the machining condition, wherein
the processing circuitry
reads the diagnosis model from the storage device based on the machining condition to perform matching between the extracted machining data and the diagnosis model, and
performs cleansing of the extracted machining data based on the diagnosis model for which the matching has been performed.

3. The machining diagnosis device according to claim 1, wherein
the cleansing is performed to exclude data for a section in which no actual machining is performed in a machining pattern formed in accordance with a machining condition and leave data for a subsection in which actual machining is performed.

4. The machining diagnosis device according to claim 1, wherein
the processing circuitry extracts the cutting section corresponding to the stable machining period based on a combination of an achievement degree of a rotational speed of a main spindle motor in the machining tool to a target value and a threshold for motor torque of the main spindle motor.

5. The machining diagnosis device according to claim 1, wherein:
the storage device stores the feature calculated by the processing circuitry as trend data, and
the processing circuitry extracts trend data for analysis to be a diagnosis target from the feature stored in the storage device and performs diagnosis using a target diagnosis model.

6. The machining diagnosis device according to claim 1, wherein:
the processing circuitry acquires, as training data, machining data during cutting and a timing to start or end collecting data for the cutting section corresponding to the stable machining period and to infer, using the training data, a timing to start or end collecting data for diagnosing a wear state of a component used in cutting.

7. The machining diagnosis device according to claim 1, further comprising:
a learning device including processing circuitry
to acquire training data in the machining diagnosis device including at least one of a torque waveform, a motor speed waveform, an acceleration waveform, a current waveform, or a voltage waveform during each of air-cutting and test machining and a timing to start or end collecting, by the machining diagnosis device, data for the cutting section corresponding to the stable machining period for at least one of the torque waveform, the motor speed waveform, the acceleration waveform, the current waveform, or the voltage waveform during each of the air-cutting and the test machining, and
to generate a trained model to infer, using the training data, a timing to start or end collecting data for diagnosing a wear state of a component used in cutting from at least one of the torque waveform, the motor speed waveform, the acceleration waveform, the current waveform, or the voltage waveform during each of the air-cutting and the test machining in the machining diagnosis device.

8. The machining diagnosis device according to claim 1, further comprising:
an inference device including processing circuitry
to acquire data in the machining diagnosis device including at least one of a torque waveform, a motor speed waveform, an acceleration waveform, a current waveform, or a voltage waveform during machining, and
to output, using a trained model to infer a timing to start or end collecting, by the machining diagnosis device, data for the cutting section corresponding to the stable machining period to acquire data for diagnosing a wear state of a component used in cutting from at least one of a torque waveform, a motor speed waveform, an acceleration waveform, a current waveform, or a voltage waveform during each of air-cutting and test machining in the machining diagnosis device, a timing to start or end collecting data for diagnosing the wear state of the component used in cutting from at least one of the torque waveform, the motor speed waveform, the acceleration waveform, the current waveform, or the voltage waveform during the machining.

9. The machining diagnosis device according to claim 1, further comprising:
a learning device including processing circuitry
to acquire training data including a diagnosis condition for the machining diagnosis device and machining data after maintenance in the machining diagnosis device, and
to generate, using the training data, a trained model to infer a correction value for each piece of diagnosis threshold data after maintenance to determine an abnormality in diagnosis based on machining data after maintenance in the machining diagnosis device.

10. The machining diagnosis device according to claim 1, further comprising:
an inference device including processing circuitry
to acquire machining data after maintenance in the machining diagnosis device, and
to output, using a trained model to infer a correction value for each piece of diagnosis threshold data after maintenance to determine an abnormality in diagnosis based on machining data after maintenance in the machining diagnosis device, a correction value for each piece of diagnosis threshold data after maintenance based on machining data after maintenance in the machining diagnosis device.

11. A machining diagnosis method, comprising:
acquiring, from a machining tool, machining data including a result of machining performed based on a machining condition;
extracting a cutting section corresponding to a stable machining period and machining data for the cutting section from the acquired machining data;
acquiring the machining condition and cleansing the machining data for the cutting section in accordance with the acquired machining condition;
calculating a feature based on the cleansed machining data; and
diagnosing machining based on the calculated feature.

12. A non-transitory computer-readable recording medium storing a program, the program causing a computer to perform operations comprising:
acquiring, from a machining tool, machining data including a result of machining performed based on a machining condition;
extracting a cutting section corresponding to a stable machining period and machining data for the cutting section from the acquired machining data;
acquiring the machining condition for cutting and cleansing the machining data for the cutting section in accordance with the acquired machining condition;
calculating a feature based on the cleansed machining data; and
diagnosing machining based on the calculated feature.

13. A learning device, comprising:
processing circuitry
to acquire training data in the machining diagnosis device according to claim 1 including at least one of a torque waveform, a motor speed waveform, an acceleration waveform, a current waveform, or a voltage waveform during each of air-cutting and test machining and a timing to start or end collecting, by the machining diagnosis device, data for the cutting section corresponding to the stable machining period for at least one of the torque waveform, the motor speed waveform, the acceleration waveform, the current waveform, or the voltage waveform during each of the air-cutting and the test machining; and
to generate a trained model to infer, using the training data, a timing to start or end collecting data for diagnosing a wear state of a component used in cutting from at least one of the torque waveform, the motor speed waveform, the acceleration waveform, the current waveform, or the voltage waveform during each of the air-cutting and the test machining in the machining diagnosis device.

14. An inference device, comprising:
processing circuitry
to acquire data in the machining diagnosis device according to claim 1 including at least one of a torque waveform, a motor speed waveform, an acceleration waveform, a current waveform, or a voltage waveform during machining; and
to output, using a trained model to infer a timing to start or end collecting, by the machining diagnosis device, data for the cutting section corresponding to the stable machining period to acquire data for diagnosing a wear state of a component used in cutting from at least one of a torque waveform, a motor speed waveform, an acceleration waveform, a current waveform, or a voltage waveform during each of air-cutting and test machining in the machining diagnosis device, a timing to start or end collecting data for diagnosing the wear state of the component used in cutting from at least one of the torque waveform, the motor speed waveform, the acceleration waveform, the current waveform, or the voltage waveform during the machining.

15. A learning device, comprising:
processing circuitry
to acquire training data including the diagnosis condition for a machining diagnosis device according to claim 1 and machining data after maintenance in the machining diagnosis device; and
to generate, using the training data, a trained model to infer a correction value for each piece of diagnosis threshold data after maintenance to determine an abnormality in diagnosis based on machining data after maintenance in the machining diagnosis device.

16. An inference device, comprising:
processing circuitry
to acquire machining data after maintenance in the machining diagnosis device according to claim 1; and
to output, using a trained model to infer a correction value for each piece of diagnosis threshold data after maintenance to determine an abnormality in diagnosis based on machining data after maintenance in the machining diagnosis device, a correction value for each piece of diagnosis threshold data after maintenance based on machining data after maintenance in the machining diagnosis device.
